(19) United States
(12) Patent Application Publication
(10) Pub. No.: US 2013/0116802 A1
(43) Pub. Date: May 9, 2013

(54) TRACKING SIMULATION METHOD

(71) Applicants: Mats Friman, Tampere (FI); Pasi Airikka, Kangasala (FI)

(72) Inventors: Mats Friman, Tampere (FI); Pasi Airikka, Kangasala (FI)

(73) Assignee: METSO AUTOMATION OY, Vantaa (FI)

(21) Appl. No.: 13/806,334

(22) PCT Filed: Jun. 30, 2010
(86) PCT No.: PCT/FI10/50564

§ 371 Date: Jan. 11, 2013

(51) Int. Cl. G05B 17/02

(52) U.S. Cl. CPC G05B 17/02
USPC 700/30

(57) ABSTRACT

A tracking simulator models an industrial process simultaneously and in parallel with the industrial process. The simulator receives control inputs provided by an automation system to control the industrial process. Based on these inputs, the simulator with its process model(s) provides simulated process outputs. In order to avoid divergence of the simulation models from the real process, the tracking simulator receives process measurements from the real process and is able to correct, i.e. update, its models based on these real process measurements and the simulator outputs. One or more of the updated or adjusting parameters for the simulation models are generated by PI or PID controller. Additionally, some of the updated parameters can be generated by an NM or SE method. The PI or PID controller can be an automatic controller tuning tool of the automation system. Additionally, some of the updated parameters can be generated by NM.

### FIELD OF THE INVENTION

The present invention relates generally to control of an industrial process by an automation system.

### BACKGROUND OF THE INVENTION

A process control or automation system is used to automatically control an industrial process such as chemical, oil refineries, paper and pulp factories. The process automation system often uses a network to interconnect sensors, controllers, operator terminals and actuators. Process automation involves using computer technology and software engineering to help power plants and factories operate more efficiently and safely.

Process simulation is a model-based representation of industrial processes and unit operations in software for studying and analyzing the behavior and performance of actual or theoretical systems. Simulation studies are performed, not on the real-world system, but on a (usually computer-based) model of the system created for the purpose of studying certain system dynamics and characteristics. The purpose of any model is to enable its users to draw conclusions about the real system by studying and analyzing the model. The major reasons for developing a model, as opposed to analyzing the real system, include economics, unavailability of a “real” system, and the goal of achieving a deeper understanding of the relationships between the elements of the system.

Process simulation always uses models which introduce approximations and assumptions but allow the description of a property over a wide range of properties, such as temperatures and pressures, which might not be covered by real data. Models also allow interpolation and extrapolation—within certain limits—and enable the search for conditions outside the range of known properties. In process automation, the simulator may use measurements to show not only how the plant is working but to simulate different operating modes and find the optimal strategy for the plant.

Simulation can be used in task or situational training areas in order to allow operators to anticipate certain situations and be able to react properly as well as to test and select alternatives based on some criteria, to test why certain phenomena occur in the operations of the system under consideration, to gain insight about which variables are most important to performance and how these variables interact, to identify bottlenecks in the process, to better understand how the system really operates (as opposed to how everyone thinks it operates), and to compare alternatives and reduce the risks of decisions.

Basic process simulator may be run with no real-time connection to a simulated process. This approach is illustrated in FIG. 1A. An automation system (e.g. Distributed Control System, DCS) 2 is arranged to control a real industrial process 3. As illustrated by dashed lines, the same automation system may also be arranged to control a process simulator 4 running a model of the industrial process. Typically, such process simulator, no matter if it is a static or dynamic simulator, cannot adapt its behavior to reality. Instead its outputs are a result of programmed models. Thus, if a process simulator is run in parallel with the real process, it typically diverges from the real process, since there are always unknown inputs and parameters that change with time. Alternatively, the process simulator 4 may be used off-line during a process design and testing or for training purposes. In that case there may be no real process 3 at all, and/or the automation system 2 is connected to control the process simulator only.

A tracking simulator, on the other hand, has the ability to adapt its behavior to reality. A tracking simulator 5 is a process simulator that runs in real-time in parallel with the real process and is provided with a connection to the real process 3, as illustrated in FIG. 1B. More specifically, the tracking simulator 5 receives process measurements from the real process 3 and is able to correct its own behavior (models) by comparing the real process measurements to the simulator outputs. In FIG. 1B, comparators (subtractors) 6 and 7 generate error signals from the real process measurements and the simulator outputs, and an update algorithm block 8 updates the parameters of the simulator model 9 such that the error (difference) between the real process measurements and the simulator outputs is reduced. An example of a tracking simulator is disclosed in Nakaya et al., MODEL PARAMETER ESTIMATION BY TRACKING SIMULATOR FOR THE INNOVATION OF PLANT OPERATION, Proceedings of the 17th IFAC World Congress, p. 2168-2173, Seoul, Korea, 2008. A known parameter algorithm may be presented by equation (1):

p(k)=p(k−1)+Ke(k) (1)

wherein p(k) is the updated simulation parameter, K is a parameter update constant, and e(k) is an error between the real process measurement and the respective simulator output, and k is an index, wherein k=1, 2, . . . , . FIG. 1C is a block diagram illustrating the prior art update algorithm for one parameter. The comparator 6 or 7 receives the process measurement to (+) input and the simulator output to the (−) input and outputs the error signal e(k). The error signal e(k) is multiplied by the parameter update constant K in a multiplier unit 81, and the multiplied error signal Ke(k) is applied to an (+) input of adder 82, while the previous parameter value p(k−1), which is a value of p(k) of at its previous calculation cycle, is applied to another (+) input of the adder 82 from a 1/Z unit 83. The function of unit 83 may be defined by equation (2):

p(k−1)=1/Z*p(k) (2)

wherein 1/Z is a single element buffer, delaying the signal with one sample instant.

As a result, the output of the adder 82 is the updated estimated parameter p(k) according to the equation above. The parameter p(k) is applied to the simulator 9 and also feedbacked to the 1/Z unit 83. Main problems associated with this type of known tracking simulator are that the parameter update is relatively slow and that it is difficult and cumbersome to select or calculate the parameter update constants K for the process parameters. It should be noted that typically there is a high number of process parameters that should be tracked and updated in the simulation model, each requiring an individual parameter update constant K.

Fukano et al., Application of Tracking Simulator to Steam Reforming Process, Yokogawa Technical Report English Edition, NO. 43 (2007), p. 13-16 discloses an application example for a tracking simulator.

### SUMMARY OF THE INVENTION

An object of the present invention is to provide a new method of simulating an industrial process. This object of the invention is achieved by the subject matter of the attached independent claims. The preferred embodiments of the invention are disclosed in the dependent claims.

An aspect of the invention is a method of simulating an industrial process, comprising

receiving a plurality of control inputs provided by an automation system controlling the industrial process,

receiving a plurality of process measurements from the industrial process,

simulating the industrial process simultaneously and in parallel with the industrial process using a model of the industrial process,

providing a plurality of simulation outputs from the model of the industrial process, each of said plurality of simulation outputs being a simulated version of a respective one of said plurality of process measurements,

adjusting the model of the industrial process with a plurality of adjusting parameters generated based on said plurality of process measurements and said plurality of simulation outputs, and

generating said at least one of said plurality of adjusting parameters by a proportional integral (PI) or proportional integral derivate (PID) controller or a like controller.

According to an embodiment, the method comprises configuring the proportional integral (PI) or proportional integral derivate (PID) controller or the like controller by an automatic controller tuning tool of the automation system.

According to an embodiment, the method comprises generating at least one other of said plurality of adjusting parameters by means other than a proportional integral (PI) or proportional integral derivate (PID) controller or a like controller.

According to an embodiment, the method comprises generating at least one other of said plurality of adjusting parameters by a search-based optimization algorithm.

According to an embodiment, said search-based optimization algorithm comprises Nelder-Mead algorithm and/or Squares of Errors (SE) calculation.

According to an embodiment, the method comprises generating and outputting a soft measurement which estimates the internal behaviour or parameter of the industrial process but which is not feasible to measure from the industrial process.

According to an embodiment, said outputting comprises displaying said soft measurement data on a screen and/or storing the soft measurement data in a storage media.

According to an embodiment, said outputting comprises sending the soft measurement data to the automation system for controlling or optimizing the industrial process and/or to a maintenance system for maintenance purposes.

Another aspect of the invention is use of a method according to any one of above embodiments for estimating future behaviour of the industrial process.

Another aspect of the invention is use of a method according to any one of above embodiments for testing response of the industrial process to different control situations.

Another aspect of the invention is a tracking simulator comprising means for implementing a method according to any one of above embodiments.

Another aspect of the present invention is an automation system comprising means for implementing a method according to any one of above embodiments.

Another aspect of the invention is a computer program comprising program code for performing a method according to any one of above embodiments when said program is run on a computer.

Another aspect of the invention is a computer program product comprising program code means stored on a computer readable medium for performing a method according to any one of above embodiments when said program product is run on a computer.

### BRIEF DESCRIPTION OF THE DRAWINGS

In the following the invention will be described in greater detail by means of exemplary embodiments with reference to the attached drawings, in which

FIG. 1A is a block diagram illustrating a prior art simulator with no real-time connection to a simulated process;

FIG. 1B is a block diagram illustrating a prior art tracking simulator;

FIG. 1C is a block diagram illustrating the update mechanism of a prior art tracking simulator shown in FIG. 1B;

FIG. 2A is a simplified block diagram illustrating a tracking simulator according to an exemplary embodiment of the invention;

FIG. 2B is a simplified block diagram illustrating an update mechanism based on a proportional integral (PI) or proportional integral derivate (PID) controller or a like controller, according to an exemplary embodiment of the invention;

FIG. 3 is a simplified block diagram illustrating a “hybrid” tracking simulator according to an exemplary embodiment of the invention;

FIG. 4 is a simplified block diagram illustrating an exemplary application of a tracking simulator in a heat exchanger process;

FIG. 5 shows an example of a tuning view in the Metso DNAautotune tool when used for tuning of a PI controller in a tracking simulator shown in FIG. 4; and

FIG. 6 shows an exemplary view in the Metso DNA system that may be displayed to an operator regarding the operation of the heat exchanger.

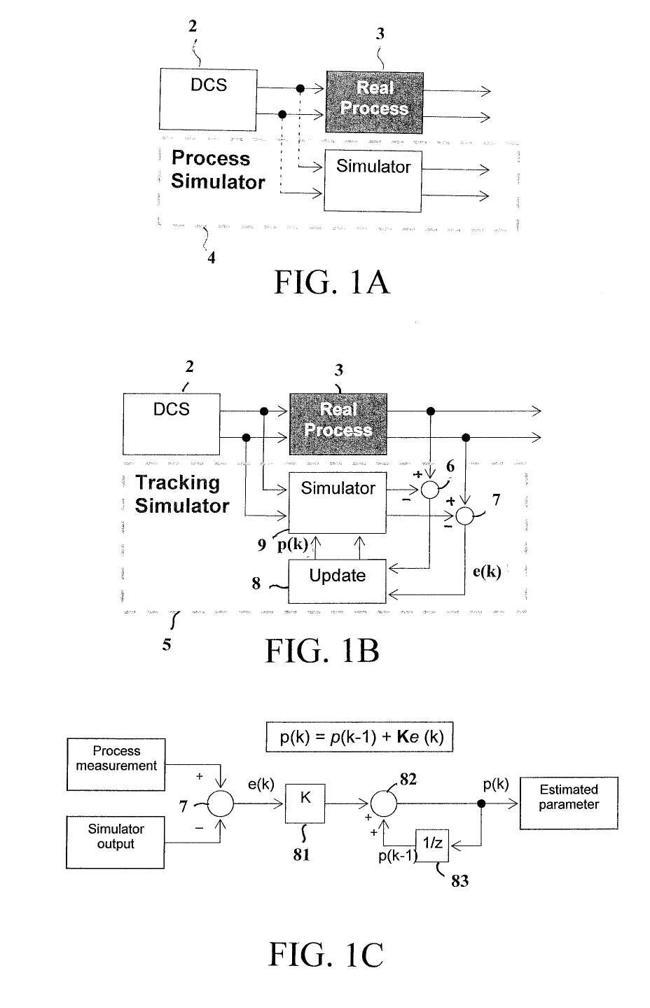

### EXAMPLE EMBODIMENTS OF THE INVENTION

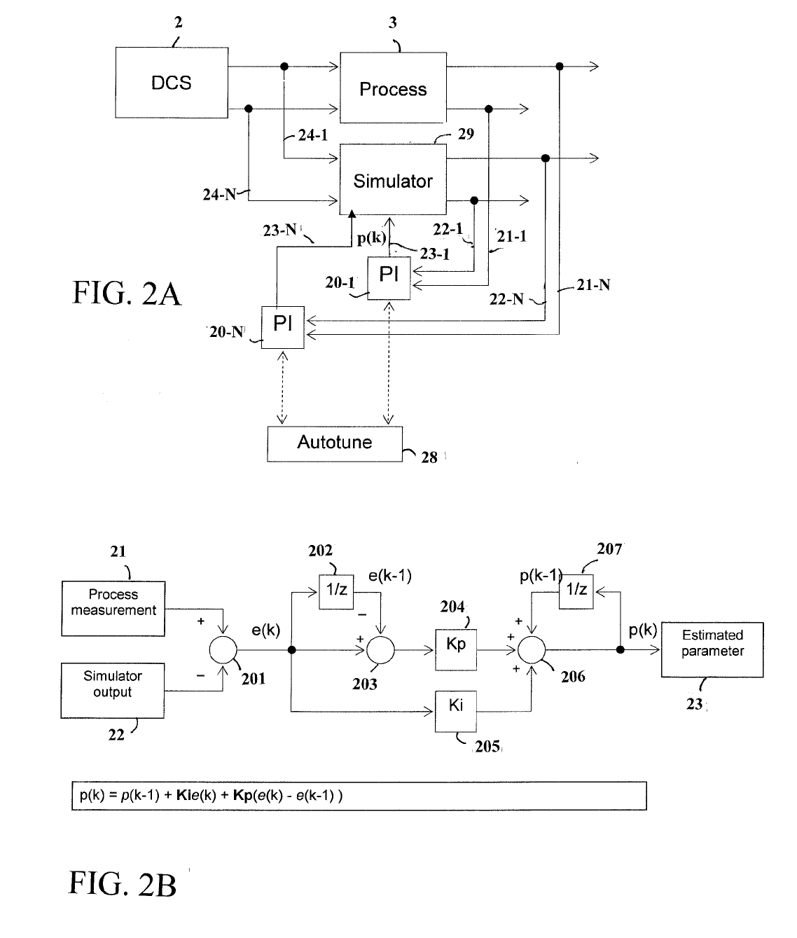

An exemplary embodiment of the invention is illustrated in FIG. 2A. The present invention can be applied in connection with any automation system (process control system) 2 and any industrial process 2 or the like. The industrial processes 3 may include, but is not limited to, processes in a processing industry, such as pulp and paper, oil refining, petrochemical and chemical industries, or processes in power plants, etc. There are various architectures for an automation system. For example, the automation system 2 may be a Direct Digital Control (DDC) system or a Distributed Control System (DCS), both well known in the art. One example of such a decentralized automation system is MetsoDNA (DNA, Dynamic Network of Applications) delivered by Metso Automation Inc. A central processing unit(s) of an automation system controlling the productive activity of an entire factory, such as a paper mill, is (are) often called a control room, which may be composed of one or more control room computer(s)/programs and process control computer(s)/programs as well as databases of an automation system. An automation system 2 may comprise a process bus/network and/or a control room bus/network, by which different process control components or computers are coupled to one another. A control room bus/network may interconnect the user interface components of the automation system 2. A control room bus/network may be a local area network, for example, based on the standard Ethernet technology. A process bus/network may, in turn, interconnect process control components. A process bus/network may be based on a deterministic token passing protocol, for instance. Process controllers may also be connected to a control room network, allowing communication between process controllers and user interfaces. It must be appreciated, however, that it is not the intention to limit the application area of the invention to any specific implementation of an automation system 2.

A process 3 that is controlled by an automation system 2 typically includes a high number of field devices, such as actuators, valves, pumps and sensors, in a plant area (field). There are various alternative ways to arrange an interconnection between an automation system 2 and a process 3 (e.g. field devices), such as two-wire twisted pair loop (4 to 20 mA analog signal), HART (Highway Addressable Remote Transducer) protocol, and other field buses (e.g. Fieldbus and Profibus). However, it is to be understood that the type or implementation of an interconnection between an automation system 2 and a process 3, e.g. between a control room and field devices, may be based on any one of the alternatives described above, or on any combination of the same, or on any other implementation. A practical plant configuration may, and typically does, include several types of automation lines or field buses in parallel, since the plant is updated and extended gradually over a long period of time.

Process measurements 21 may include any measurement of any desired variables or properties in a process 3, such as a flow rate, a pressure, a temperature, a valve position, etc. These process variables can be measured with dedicated sensors arranged in the field of a process plant. Inputs 24 from an automation system 2 to a process 3 and to a simulator 29 may include, but are not limited to, control inputs to field devices.

A process 3 is typically controlled by control loops/circuits. A control loop or circuit may contain, for instance, a process to be controlled, a controlled field device, a measuring sensor/transmitter, and a controller. The controller may give the field device a control signal as an analog current signal or a digital control message, for example. The measuring sensor may measure a controlled variable, and a measurement product obtained is fed back to the controller, where it is compared with a given reference value. On the basis of the difference variable, the controller calculates the updated control for the field device. Usually the controller functions in such a manner that it minimizes the difference variable by a suitable control algorithm, such as a PI or PID algorithm. This control algorithm is typically tuned for each field device during mounting or operation.

In the exemplary embodiment shown in FIG. 2A, a tracking simulator is provided that models an industrial process 3 simultaneously and in parallel with the industrial process 3. The exemplary tracking simulator comprises a simulator unit 29 and one or more PI controllers 20-1 . . . 20-N. The simulator unit 29 receives one or more control inputs 24-1 . . . 24-N provided by an automation system 2 to control the industrial process 3. Based on these inputs 24, the simulator unit 29 with its process model(s) provides simulated (estimated) process outputs 22-1 . . . 22-N (e.g. flow rate, temperature, pressure) which represent the real process outputs as accurately as possible with the process model(s) employed. In order to avoid divergence of the model(s) from the real process 3, the tracking simulator is provided with a connection to the real process 3. More specifically, the tracking simulator receives one or more process measurements 21-1 . . . 21-N from the real process 3 and is able to correct, i.e. update, its own behavior (models) based on these real process measurements 21 and the simulator outputs 22. In accordance with the principles of the present invention, one or more of the updated or adjusting parameters 23-1 . . . 23-N (e.g. parameters p(k)) for the simulator unit are generated by a proportional integral (PI) or proportional integral derivate (PID) controller or a controller based on any other control algorithm 20.

More specifically, in this exemplary embodiment, each pair of the process measurements 21-1 . . . 21-N and the simulator outputs 22-1 . . . 22-N are applied as inputs to a respective PI or PID or like controller 20-1 . . . 20-N which outputs a respective update or adjusting parameter 23-1 . . . 23-N to the simulator unit 29. It should be appreciated that the number N (wherein N=1, 2, 3, . . . ) can be freely selected. It should also be appreciated that the number of process measurements 21, simulator outputs 22, controllers 20 and/or update parameters 23 may differ from each other in a same embodiment.

PI and PID controllers are typically used to automatically adjust some variable to hold a measurement (or process variable) at a set-point. The set-point is where you would like the measurement to be. Error is defined as the difference between set-point and measurement. The output of PI and PID controllers will change in response to a change in measurement or set-point.

PI is an acronym for “proportional and integral”. PI controller is a controller that includes elements with these two functions. PID is an acronym for “proportional, integral, and derivative.” A PID controller is a controller that includes elements with those three functions. Acronyms PI and PID may also be used at the element level: the proportional element is referred to as the “P element,” the integral element as the “I element,” and the derivative element as the “D element”. It may be said the elements P, I and D of a controller produce outputs with the following nature:
P element: proportional to the error at the instant t, i.e. the “present” error. With a P controller offset (deviation from a set-point) is present. Increasing the controller gain will make the loop go unstable.
I element: proportional to the integral of the error up to the instant t, which can be interpreted as the accumulation of the “past” error. With the integral element, the controller output is proportional to the amount of time the error is present. The I element tends to eliminate the offset. The response may be somewhat oscillatory and can be stabilized some by adding derivative action.
D element: proportional to the derivative of the error at the instant t, which can be interpreted as the prediction of the “future” error. With derivative element D, the controller output is proportional to the rate of change of the measurement or error. The controller output is calculated by the rate of change of the measurement with time.

An exemplary updating apparatus or algorithm using PI controller 20 may operate according to the equation (3):

p(k)=p(k−1)+Kᵢe(k)+Kₚ(e(k)−e(k−1)) (3)

wherein

p(k) is the updated parameter,

e(k) is an error between the real process measurement and the respective simulator output,

Kₚ is a proportional gain,

Kᵢ is an update constant, and

k is an index, wherein k=1, 2, . . . , .

FIG. 2B shows an exemplary block diagram for a PI controller/control algorithm 20 implementing the equation (3).

In a PI controller portion, the comparator 201 receives the process measurement 21 to one input (+) and the simulator output 22 to another input (−) and outputs the error signal e(k). The error signal e(k) is applied to a 1/Z unit 202 and to one input (−) of a comparator 203. The 1/Z unit 202 may be a single-element buffer that delays the signal with one sample instant. The previous parameter value e(k−1), which is a value of e(k) of at its previous calculation cycle, is applied to another input (−) of comparator 203. As a consequence, a rate of error signal e(k)−e(k−1) (i.e. the change) is outputted from the comparator 203 and then multiplied by the proportional gain Kₚ in a multiplier 204. The output Kₚ(e(k)−e(k−1)) of the multiplier 204 is applied to one input (+) of an adder 206. The Kₚ(e(k)−e(k−1)) is the P part of the PI controller.

In the exemplary embodiment, the error signal e(k) from the comparator 201 is also applied to a multiplier 205, which multiplier 205 multiplies the error signal e(k) by the constant K and outputs Kᵢe(k) to another input (+) of the adder 206. the Kᵢe(k) is the I part of the PI controller.

To the third input (+) of the adder 206 is applied the previous updated parameter p(k−1), which is a value of p(k) of at its previous calculation cycle from a 1/Z unit 207. The 1/Z unit 207 may be a single-element buffer that delays the signal with one sample instant. The adder 206 outputs the new updated estimated parameter p(k) 23 for the simulator unit 29. The updated parameter p(k) is also applied to the 1/Z unit 207.

The inventive tracking simulator wherein the model parameter(s) is updated using a proportional integral (PI) or proportional integral derivate (PID) controller or a like controller, enables fast update of the model parameters. Thus, the model parameters and thereby the simulation model more accurately and faster track the changes in the real process in comparison with the conventional tracking simulators.

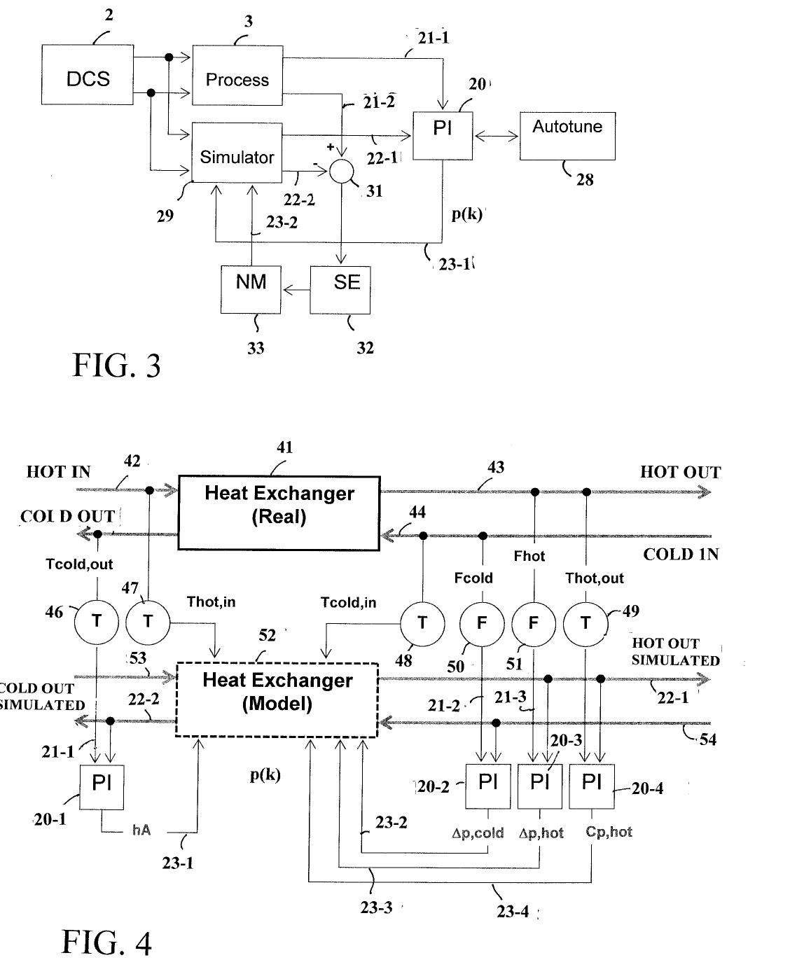

It should be appreciated that, in addition to using the one or more proportional integral (PI) and/or proportional integral derivate (PID) controller and/or a like controller for updating one or more parameters of a tracking simulator, there may also be one or more other type of arrangements for updating one or more other parameters of the same tracking simulator. In other words, all parameters are not necessarily updated using a proportional integral (PI) or proportional integral derivate (PID) controller or a like controller. For example, sometimes the direction of a parameter p(k) affecting on an output value 22 may change with an operating point of the process. In that case, a PI controller can not be utilized to update such parameter, but the Nelder-Mead algorithm, or any similar search-based optimization algorithm can preferably be applied in addition to the one or more PI/PID controllers discussed above. Exemplary embodiment of such “hybrid” tracking simulator is illustrated in FIG. 3. The automation system 2, the real process 3, the PI controller 20 and the simulator unit 29 may be similar to those described with reference to FIG. 2A. The updated or adjusting parameter 23-1 (e.g. parameters p(k)) for the simulator unit 29 is generated by a proportional integral (PI) or proportional integral derivate (PID) controller or a like controller 20 as described above. The other updated or adjusting parameter 23-2 (for the simulator unit 29 are generated by a Nelder-Mead algorithm 33. In the exemplary embodiment, the process measurement 21-2 and the simulator output 22-2 are applied to inputs (+) and (−) of a comparator 31 which provides an error signal which represents the difference between the process measurement 21-2 and the simulator output 22-2. The squares of errors (SE) is formed from the error signal in an SE block 32 and applied to the Nelder-Mead algorithm block 21.

Another significant advantage is that a tracking simulator, which is based on use of PI or PID or similar controllers, can be tuned using autotuning tools which are presently used for tuning PI and PID controllers in the real process. Thus, such autotuning tools are readily available in the automation system. In the exemplary embodiments of FIGS. 2A and 3, such autotuning tool(s) or device(s) is generally represented by an autotune block 28 which is communicatively coupled to the PI controllers 20-1 . . . 20-N. An example of a suitable tuning tool is DNAautotune from Metso Automation Inc. The tool is integrated into MetsoDNA's user interface, so that the tool is always available at the user interface when it is needed. The tuning process is automatic in the sense that once it has started, no human interference is needed during the process tests. However, the results need to be accepted by the user before proposed tuning parameters are downloaded to the PI/PID controller. No changes are made to the online controller without confirmation. The new set of control parameters are calculated using the lambda-tuning method based on the process model and target speed of the controller. It is crucial that the process model accurately captures the real process dynamics. To make sure the process model is good, DNAautotune offers the user simulation trends, as well as the option to graphically edit the process model to fit the data better, in the event of strong disturbances. A user can select the target speed and simulate set point changes with different target speed choices, because the fastest tuning is not always the best one. The proposed tuning parameters will be downloaded onto the online controller once the user accepts them by clicking the “Download to Controller” button. The user gets a printed one-page report of the controller tuning operation.

Let us examine the tracking simulation and the autotuning thereof by means of an example wherein the real process is a heat exchanger. A simplified block diagram of this arrangement is illustrated in FIG. 4. The real heat exchanger 41 is arranged to receive a hot incoming pipe 42 that conveys a hot fluid, for example, and a cold incoming pipe 44 that conveys a cold fluid, for example. The hot fluid, which has passed through the heat exchanger 41, is arranged to exit via a hot outgoing pipe 43. Similarly, the cold fluid, which has passed through the heat exchanger 41, is arranged to exit via a cold outgoing pipe 45. While the cold and hot fluids are passing through the heat exchanger 41, heat is exchanged from the hot fluid to the cold fluid, and the former will be cooled down and the latter will be heated up, as is well known in the art.

A tracking simulator 52 is provided that models heat exchanger 41 simultaneously and in parallel with the heat exchanger 41. The simulator 52 provides a simulated hot output 22-1, which represents the fluid in the hot outgoing pipe 43, and a simulated cold output 22-2, which represents the cold fluid in the cold outgoing pipe 45. In the exemplary embodiment, a “simulated” hot incoming pipe 53 and a “simulated” cold incoming pipe 54 are not simulated values but provided by measuring the fluid temperature T_{hot,in} of the real hot incoming pipe 42 by a temperature sensor 47, and by measuring the fluid temperature T_{coldt,in} of the real cold incoming pipe 44 by a temperature sensor 48, respectively. Control inputs from an automation system are not shown in FIG. 4, as they are not relevant to the description of the embodiment.

In the exemplary embodiment illustrated, the simulation model 52 of the heat exchanger contain four simulation parameters 23-1, 23-2, 23-3, and 23-4, which are arranged to be updated by PI controllers 20-1, 20-2, 20-3, and 20-4, respectively.

A temperature sensor 46 is arranged to measure the fluid temperature T_{cold,out} of the cold outgoing pipe 45 and to provide the measured temperature to one input of the PI controller 20-1 as a process measurement 21-1. The simulated cold output 22-2 of the simulator 52 is applied to another input of the PI controller 20-1. The updated parameter 23-1 of the PI controller 20-1 is h*A, wherein h is a heat transfer coefficient and A is a heat exchange area of the heat exchanger.

A flow meter (flow indicator) 50 is arranged to measure the flow rate F_{cold} of the cold incoming pipe 44 and to provide the measured flow rate to one input of the PI controller 20-2 as a process measurement 21-2. The simulated cold input 52 (i.e. the measured temperature T_{cold,in}) of the simulator 52 is applied to another input of the PI controller 20-2. The updated parameter 23-2 of the PI controller 20-2 is Δp,cold, i.e. a pressure difference in the cold input.

A flow meter (flow indicator) 51 is arranged to measure the flow rate Fₕₒₜ of the hot outgoing pipe 43 and to provide the measured flow rate to one input of the PI controller 20-3 as a process measurement 21-3. The simulated hot output 22-1 of the simulator 52 is applied to another input of the PI controller 20-3. The updated parameter 23-3 of the PI controller 20-3 is Δp,hot, i.e. a pressure difference in the hot output.

A temperature sensor 49 is arranged to measure the fluid temperature T_{hot,out} of the hot outgoing pipe 43 and to provide the measured temperature to one input of the PI controller 20-4 as a process measurement 21-4. The simulated hot output 22-1 of the simulator 52 is applied to another input of the PI controller 20-4. The updated parameter 23-4 of the PI controller 20-4 is Cp, hot, wherein Cp,hot is the heat capacity of the hot fluid.

At the setup of the tracking simulator, after the process measurement inputs to the simulator 52 and the PI controllers 20-1 . . . 20-4 have been connected, the real-time simulation can be started. The PI controllers 20-1 . . . 20-4 are autotuned by an autotuning tool (e.g. DNAautotune) and connected to an automatic mode. As a result, the PI controllers 20-1 . . . 20-4 will estimate the unknown parameters 23.

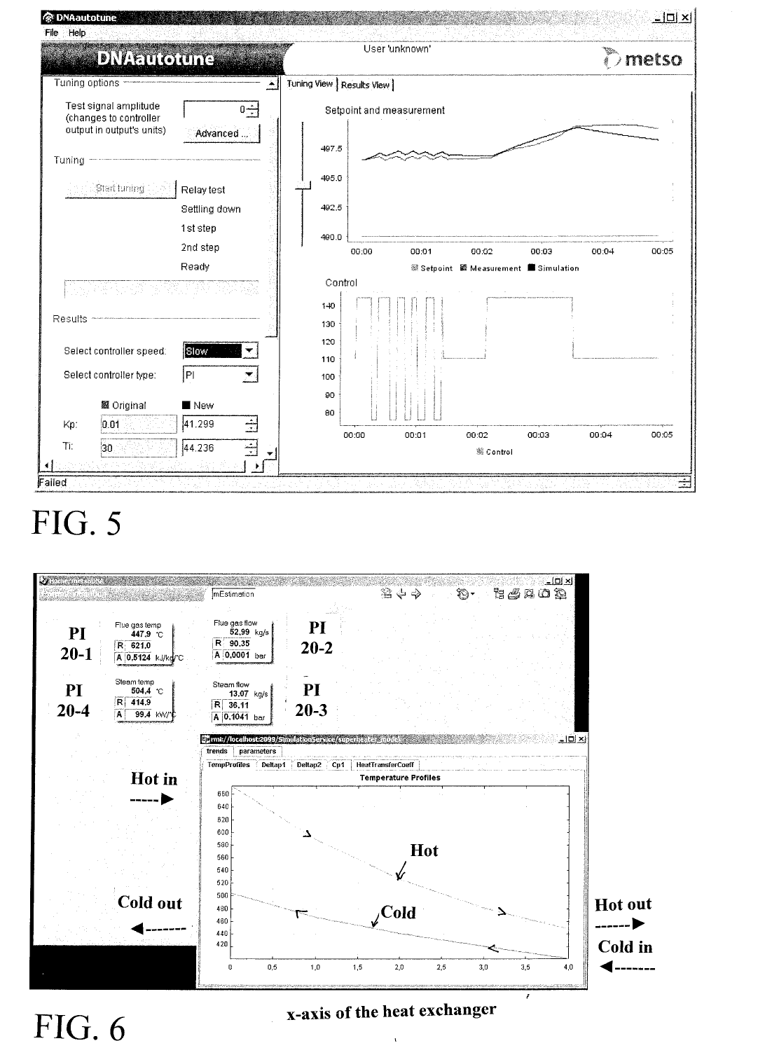

FIG. 5 illustrates an example of a tuning view in the Metso DNAautotune tool that may be used in case of the tracking simulator shown in FIG. 4. Controller speed is selected to be “slow” and the controller type is selected as “PI”. By changing the values of Kp and Ti, the autotuner can search appropriate configuration values for the PI controller. At the end of the tuning process, the provisional gain Kp is set “41.299” and the integral time Ti is set “44.236”. The control input and the measured and simulated outputs are illustrated by graphs. Thus, the tuning parameters need not to be taken out of the air, or with complicated calculation as in the conventional tracking simulators.

By means of embodiments of the present invention, an ordinary process simulator can be readily extended to a tracking simulator, which can be used for many purposes, including soft sensors, prediction of future plant behaviour, visualization of profiles and shapes, parameter estimation, and plant optimization.

Some embodiments of the invention may generate and output a soft measurement which estimates the internal behaviour or parameter of the industrial process but which is not feasible to measure from the industrial process. In some embodiments the outputting may comprises displaying said soft measurement data and/or other simulation data on a screen and/or storing the soft measurement data and/or other simulation data in a digital storage media. In some embodiments of the invention, the outputting may comprise sending the soft measurement data and/or other simulation data to the automation system for controlling or optimizing the industrial process and/or to a maintenance system for maintenance purposes.

FIG. 6 shows an exemplary view that may be displayed to an operator regarding the operation of the heat exchanger in the Metso DNA system. At the upper left corner the four boxes give information relating to the PI controllers 20-1 . . . 20-4. In each box, the topmost value is the output value 22 from the estimator, the middle value is the value of the respective process measurement 21, and the lowermost value is the value of the updated simulation parameter 23 from the PI controller 20. Based on the simulation results various graphs can be depicted. In FIG. 6, the temperatures profiles along the longitudinal axis (x-axis) of the heat exchanger are depicted for the hot stream from the hot in pipe 42 to the hot out pipe 43 and, in the reverse direction, from the cold in pipe 44 to the cold out pipe 45. The simulated graphs indicate how the heat exchange proceeds within the heat exchanger 44. This is an example of so-called “soft” measurements, i.e. measurement data that can be obtained by means of simulation, while the same data is difficult or impossible to measure directly from the real process.

The techniques described herein may be implemented by various means. For example, these techniques may be implemented in hardware (one or more devices), firmware (one or more devices), software (one or more modules), or combinations thereof. For a firmware or software, implementation can be through modules (e.g., procedures, functions, and so on) that perform the functions described herein. The software codes may be stored in any suitable, processor/computer-readable data storage medium(s) or memory unit(s) and executed by one or more processors/computers. The data storage medium or the memory unit may be implemented within the processor/computer or external to the processor/computer, in which case it can be communicatively coupled to the processor/computer via various means as is known in the art. Additionally, components of systems described herein may be rearranged and/or complimented by additional components in order to facilitate achieving the various aspects, goals, advantages, etc., described with regard thereto, and are not limited to the precise configurations set forth in a given figure, as will be appreciated by one skilled in the art.

The description and the related figures are only intended to illustrate the principles of the present invention by means of examples. Various alternative embodiments, variations and changes are obvious to a person skilled in the art on the basis of this description. The present invention is not intended to be limited to the examples described herein but the invention may vary within the scope and spirit of the appended claims.

1. A method of simulating an industrial process, comprising
receiving a plurality of control inputs provided by an automation system controlling an industrial process,
receiving a plurality of process measurements from the industrial process,
simulating the industrial process simultaneously and in parallel with the industrial process using a model of the industrial process,
providing a plurality of simulation outputs from the model of the industrial process, each of said plurality of simulation outputs being a simulated version of a respective one of said plurality of process measurements,
adjusting the model of the industrial process with a plurality of adjusting parameters generated based on said plurality of process measurements and said plurality of simulation outputs, and
generating at least one of said plurality of adjusting parameters by a proportional integral or proportional integral derivate controller or a like controller.

2. A method according to claim 1, comprising
configuring the proportional integral or proportional integral derivate controller or the like controller by an automatic controller tuning tool of the automation system.

3. A method according to claim 1, comprising
generating at least one other of said plurality of adjusting parameters by means other than a proportional integral or proportional integral derivate controller or a like controller.

4. A method according to claim 1, comprising generating at least one other of said plurality of adjusting parameters by a search-based optimization algorithm.

5. A method according to claim 4, wherein said search-based optimization algorithm comprises Nelder-Mead algorithm and/or Squares of Errors algorithm.

6. A method according to claim 1, comprising generating and outputting a soft measurement which estimates the internal behaviour or parameter of the industrial process but which is not feasible to measure from the industrial process.

7. A method according to claim 6, wherein said outputting comprises displaying said soft measurement data on a screen and/or storing the soft measurement data in a storage media.

8. A method according to claim 6, wherein said outputting comprises sending the soft measurement data to the automation system for controlling or optimizing the industrial process and/or to a maintenance system for maintenance purposes.

9-14. (canceled)

15. A method according to claim 1, comprising estimating future behaviour of the industrial process.

16. A method according to claim 1, comprising testing response of the industrial process to different control situations.

17. A tracking simulator, comprising
means for receiving a plurality of control inputs provided by an automation system controlling an industrial process,
means for receiving a plurality of process measurements from the industrial process,
means for simulating the industrial process simultaneously and in parallel with the industrial process using a model of the industrial process,
means for providing a plurality of simulation outputs from the model of the industrial process, each of said plurality of simulation outputs being a simulated version of a respective one of said plurality of process measurements,
means for adjusting the model of the industrial process with a plurality of adjusting parameters generated based on said plurality of process measurements and said plurality of simulation outputs, and
means for generating at least one of said plurality of adjusting parameters by a proportional integral or proportional integral derivate controller or a like controller.

18. An automation system, comprising an industrial process, an automation system connected to the industrial process and configured to provide a plurality of process control signals to the industrial process and to receive a plurality of process measurements from the industrial process, and a tracking simulator, said tracking simulator further comprising
a simulator unit configured to simulate the industrial process simultaneously and in parallel with the industrial process using a model of the industrial process, said simulator unit having a plurality of first inputs connected to receive said plurality of process control signals provided by the automation system, a plurality of second inputs connected to receive said plurality of process measurements from the industrial process, and a plurality of simulation outputs, each of said plurality of simulation outputs being a simulated version of a respective one of said plurality of process measurements,
at least one proportional integral or proportional integral derivate controller or a like controller having one or more inputs configured to receive one or more of said plurality of process measurements and one or more said plurality of simulation outputs, and one or more adjustment outputs arranged to adjust the model of the industrial process in said simulator unit.

19. A system according to claim 18, comprising an automatic controller tuning tool of the automation system arranged to configurate the proportional integral or proportional integral derivate controller or the like controller.

20. A system according to claim 18, further comprising a search-based optimizer unit configured to receive one or more of said plurality of process measurements and one or more said plurality of simulation outputs, and one or more adjustment outputs arranged to adjust the model of the industrial process in said simulator unit.

21. A system according to claim 20, wherein said search-based optimizer unit comprises a Nelder-Mead optimizer and/or a Squares of Errors optimizer.

22. A tangible computer-readable medium including contents that are configured to cause a computer system to diagnose a control valve by performing a method comprising
receiving a plurality of control inputs provided by an automation system controlling an industrial process,
receiving a plurality of process measurements from the industrial process,
simulating the industrial process simultaneously and in parallel with the industrial process using a model of the industrial process,
providing a plurality of simulation outputs from the model of the industrial process, each of said plurality of simulation outputs being a simulated version of a respective one of said plurality of process measurements,
adjusting the model of the industrial process with a plurality of adjusting parameters generated based on said plurality of process measurements and said plurality of simulation outputs, and
generating at least one of said plurality of adjusting parameters by a proportional integral or proportional integral derivate controller or a like controller.
